(19) United States
(12) Patent Application Publication
(10) Pub. No.: US 2013/0235702 A1
(43) Pub. Date: Sep. 12, 2013

(54) INSTALLATION FOR CONTROLLING THE PLAYING TIME OF A SPORTING EVENT

(71) Applicants: Pascal Saguin, Saint Pierre d'Allevard (FR); Pascal Champaney, Letouvet (FR); Philippe Turlier, Sassebage (FR)

(72) Inventors: Pascal Saguin, Saint Pierre d'Allevard (FR); Pascal Champaney, Letouvet (FR); Philippe Turlier, Sassebage (FR)

(73) Assignee: ADEUNIS R F, Crolles (FR)

(21) Appl. No.: 13/806,617

(22) PCT Filed: Jun. 24, 2011
(86) PCT No.: PCT/FR11/51458

§ 371 Date: Dec. 21, 2012

(30) Foreign Application Priority Data
Jun. 30, 2010 (FR) 10/02728

(51) Int. Cl. G08C 23/02

(52) U.S. Cl. CPC G08C 23/02
USPC 367/198

(57) ABSTRACT

Installation (1) for controlling the playing time of a sporting event, in particular of the type found in basketball, comprising:—a portable system (2) for picking up and detecting a whistle blow (S4) that signals a stoppage in the playing time, said portable system converting the audible signals into digital signals, digitally processing these digital signals and outputting a digital refereeing signal (S23) in response to the detection of the whistle blow; and—a fixed system (3) for controlling the playing time, having a digital radio connection to the portable system and comprising control means (31) that stop and/or start a clock (32) that counts down the playing time in response to the reception of the digital refereeing signal. The invention also relates to just the portable system and to just the fixed system specially designed for the portable system, and also to a time-multiplexing digital audio communications terminal incorporating such a portable system.

### TECHNICAL FIELD

The present invention relates to a portable system for picking up and detecting an acoustic so-called refereeing signal, signaling a stoppage and/or resumption of the playing time of a sporting event, designed to be worn by a referee at the sporting event.

It also relates to a digital audio communication terminal for audio communication between several referees incorporating such a portable pickup and detection system.

It also relates to a fixed control system for controlling the playing time of the sporting event, designed to be wirelessly connected with such a portable pickup and detection system, as well as a control installation for controlling the playing time comprising such a fixed control system wirelessly connected with such a portable pickup and detection system.

### BRIEF DISCUSSION OF RELATED ART

During certain sporting events, and in particular during basketball games or other group sports governed by the same type of rules as in basketball regarding playing time, it is common practice for the playing time countdown to be stopped each time a play stoppage is indicated by one of the referees, usually the head referee or the only referee present. In this way, only actual periods of play are taken into account to assess the playing time of the match in progress, and interruptions due in particular to replacing players, injuries, faults, etc. are not counted in the playing time.

These sporting events are thus subject to the stopwatch, which traditionally counts down the playing time, and any referee intervention must stop the stopwatch to deduct the stoppage times during play, in other words not take those interruptions in the play into account in the overall playing time allotted for the match in progress.

In many cases, the referee signals the stoppage of the playing time by a whistle blow, the whistle generally being duly approved and referenced by the federation in charge of these sporting events or any other accredited organization for the sporting events. It is also possible to consider that that same referee may indicate the resumption of the playing time using that same whistle blow, which then triggers the start or stop of the clock.

In certain sports, such as basketball, the actual playing phases are particularly quick and broken up, with many stoppages in play over the course of the match, such that it is common to forget or delay stopping the clock, which causes disputes that are always delicate for referees to resolve.

To resolve this issue, it is known to use automatic systems for detecting whistle blows and stopping the clock. It is thus known from document EP 0 712 508 B1 to use a remote-controlled timekeeping installation that includes:
several portable systems, each provided on the one hand with a microphone that measures external sounds and delivers raw analog measuring signals and, on the other hand, a remote-controlled portable transmitter that transmits those raw analog measuring signals; and
a fixed system comprising a radio receiver placed on the score table, wirelessly connected with the remote-controlled portable transmitters, followed by a mixer that mixes the raw analog measuring signals, then an assembly of a high-pass filter and low-pass filter, then an electronic control circuit that delivers a switching signal to the clock.

The connection between the portable system and the fixed system is thus done using an analog wireless transmission, in frequency modulation (FM), in frequencies chosen to be distinct from the transmission frequencies of external electronic equipment, such as television cameras, the security team's communication equipment, etc.

The detection of the whistle blow takes place in the fixed system, in other words at the score table, in particular using the high-pass filter, the cutoff frequency of which substantially corresponds to the transmission frequency of the whistle blow, so as to allow frequencies higher than the cutoff frequency (or whistle frequency) and attenuate frequencies below the cutoff frequency.

However, this type of remote-controlled timekeeping installation has a number of drawbacks, due in particular to the analog radio link between the portable systems and the fixed system.

In fact, this analog radio link deforms and colors the transmitted analog signals and modifies their signature, thereby affecting the reliability of their detection.

In fact, the components used for the transmission, transmission [sic] and analysis of the analog signals have unique characteristics (bandwidth, distortion, different filter effects, etc.), which modify the analog signal permanently. The system is then said to color the analog signal, in other words to modify the spectral response of that analog signal. Each transformation of the analog signal generated by these components necessarily creates background noise, since each component creates such noise. The major drawback of an analog system is the irreversible deterioration of the analog signal, the system being incapable of distinguishing the useful signal from the background noise.

Thus, the radio link being analog, there is no way to recover a communication if it is scrambled or even to detect the failure of the system, such that on the one hand, whistle blows may not be detected by the fixed system following electromagnetic disruptions caused by external electronic devices, and on the other hand, the same external electronic devices may disrupt the transmitted analog signal to the point of erroneously triggering stoppage of the playing time.

Furthermore, in the case of the installation disclosed in document EP 0 712 508 B1, the detection of the whistle blow occurs after the radio receiver of the score table, with simple bandpass analog filtering intended to detect the frequency of the whistle. It has, however, been observed with this type of installation that any acoustic signal with a frequency component of the same nature, for example such as whistles from the spectators, the crunch of shoe soles on the ground, etc. is interpreted as a whistle blow, thereby triggering an unwanted stoppage of the clock.

Thus, this installation using analog communication systems has a sometimes prohibitive lack of reliability, as these systems are sources of conflict between teams and referees when whistle blows emitted by the referee are not detected and when outside sounds (whistles from the public, the crunch of shoe soles, etc.) erroneously triggers a stoppage of the clock.

The state of the art may also be illustrated by the teaching of international application WO 00/73858, which discloses a portable system (signaling device) for picking up and detecting an acoustic so-called refereeing signal (sensor signal), in particular of the whistle blow type, signaling a stoppage and/or resumption of the playing time of the sporting event. This portable system includes a controller (signaling device controller) that performs a spectral analysis to determine the emission of the whistle blow, or an analysis of the signature parameters of the detection signal such as the level, duration and frequency components. However, the spectral analysis and this taking into account of the aforementioned signature parameters are insufficient to obtain reliable detection not sensitive to whistles from the public, the crunching of shoe soles on the ground, etc. Thus, this portable system generally leads to unwanted stoppages of the clock.

### BRIEF SUMMARY

The present invention aims to resolve these drawbacks by proposing a portable system for picking up and detecting an acoustic so-called refereeing signal, in particular of the whistle blow type, that allows reliable detection of the acoustic refereeing signal and that is free from the faulty analog radio link.

One aim of the present invention is to provide a portable system for picking up and detecting the acoustic refereeing signal that makes it possible to verify the proper operation and availability of the system.

Another aim of the present invention is to provide a portable system for picking up and detecting the acoustic refereeing signal that avoids false triggering of the stoppage of the playing time due to radio disruptions or outside sounds.

Another aim of the present invention is to provide a portable system for picking up and detecting the acoustic refereeing signal that makes it possible to take the echo in a room into account.

Another aim of the present invention is to provide a digital audio communication terminal that incorporates such a portable pickup and detection system, thereby making it possible to use a same terminal for audio communication between several referees and to detect the whistle blow.

Another aim of the present invention is to provide a fixed system for controlling the playing time designed to be linked by radio with such a portable pickup and detection system, where the fixed system is particularly adapted to that portable system.

Another aim of the present invention is to provide a fixed system for controlling the playing time that has a simple design and allows a rapid and reliable stoppage of playing time.

Another aim of the present invention is to provide an installation for controlling the playing time comprising at least one such portable system and one such fixed system, that allows reliable detection of the whistle blow that prevents false triggering of the stoppage of the playing time.

To that end, it proposes a portable system for picking up and detecting a whistle blow that signals a stop and/or start in the playing time of a sporting event, in particular such as a basketball match or other groups sport, the portable system being designed to be worn by a referee for the sporting event and comprising:
acoustic measuring means, in particular of the microphone type, designed to measure the outside acoustic signals and deliver raw analog measuring signals in response to the measurement of the outside acoustic signal;
analog/digital conversion means connected to the acoustic measuring means and designed to convert the raw analog measuring signals into digital measuring signals;
digital processing means, in particular of the digital signal processor (DSP) type, connected to the analog/digital conversion means and designed to process and analyze the digital measuring signal so as to detect the transmission or lack thereof of the acoustic refereeing signal from among the external acoustic signals measured by said acoustic measuring means, said digital processing means delivering a digital refereeing signal in response to the detection of the acoustic refereeing signal; and
transmission means connected to the digital processing means and designed to emit said digital refereeing signal;
   said portable system being remarkable in that the digital processing means comprise means for comparing the time profile of the amplitude envelope of the digital measuring signals with a time profile of a reference envelope, so as to detect a signal having a time profile of the acoustic power envelope that corresponds substantially to the time profile of the reference envelope.

Thus, with this portable system, the detection of the acoustic refereeing signal takes place directly in the system worn by the referee, and that detection is done with no analog processing on the raw analog measuring signals, with the potential exception of an amplification, but is done using transparent digital processing that does not color and or deform the raw analog measuring signals.

In this way, the detection of the acoustic refereeing signal, hereafter called the whistle blow, is done before the radio transmission to the fixed system (outlined later) of the score table. In this way, owing to the invention, there is no risk of distortion and/or coloring of the signals during wireless communication to the score table, the detection of the whistle blow occurring before the wireless communication to the fixed system. It is of course possible to consider this acoustic refereeing signal being transmitted by types of sound notification other than the whistle, for example such as a horn.

In one particular embodiment, the refereeing signal serves only to indicate stoppage of the playing time, and the resumption of the playing time is signaled using another method, for example vocally or manually.

Following the detection of the whistle blow by the digital processing means, the system transmits a simple digital refereeing signal to the fixed system; such a digital refereeing signal, which indicates the detection of the acoustic refereeing signal, is significantly less sensitive to the electromagnetic disruptions caused by outside electronic devices. Thus, according to the invention, the radio link between the portable system and the fixed system is a digital radio link that has a number of advantages, such as the possibilities of transmitting the digital refereeing signal several times for safety, verifying the integrity of the digital radio link, guaranteeing the information transmitted by that digital radio link, etc.

Furthermore, the digital processing means make it possible to detect the whistle blow particularly reliably, not limited to a simple frequency analysis, which advantageously makes it possible to avoid false detections due to confusion between the whistle blow and outside acoustic signals having a frequency component of the same nature, for example such as whistles from the public, the crunch of shoe soles on the ground, etc. In fact, these digital processing means make it possible to base the detection of the whistle blow on other parameters representative of the whistle blow, but not representative of those external acoustic signals.

More specifically, the detection of the whistle blow is done by analyzing the time profile of the amplitude envelope of the digital measuring signals, since a whistle blow generally has a fairly specific envelope profile, traditionally with an abrupt increase in power followed by a power leveling off, and lastly a slow decrease in the power.

The analysis of this envelope profile is particularly advantageous to distinguish the whistle blow from the aforementioned surrounding voices, ambient noise, and acoustic signals having a frequency component of the same nature. This reference envelope profile thus forms a sort of signature of the whistle blow that reinforces the reliability of the detection of that same whistle blow.

Advantageously, the time profile of the reference envelope is defined by the following parameters:
an increase in the acoustic power by a first predetermined power value, in particular approximately 30 to 40 dB, relative to a base power associated with an ambient background noise, over a first period of time, in particular in the vicinity of several milliseconds;
an acoustic power leveling off over a second period of time, in particular approximately 50 ms, following the first period of time and where the second period of time is longer than the first period of time, this leveling off potentially having an increase in the acoustic power by a second predetermined power value, in particular in the vicinity of 5 to 6 dB, over the second period of time, the second power value being lower than the first power value; and
a decrease in the acoustic power until the base power is substantially reached, over a third period of time, in particular approximately 200 to 400 ms, following the second period of time, where the third period of time is longer than the second period of time.

Such a reference envelope is advantageous in light of the envelope profiles traditionally observed with an abrupt increase in power followed by a leveling off of the power, and lastly a slow decrease in the power.

Preferably, the digital processing means comprise parameterization or modification means for the time profile of the reference envelope, in particular so as to account for the presence of an echo inside a gymnasium.

In this way, it is possible to account for the inside architecture of a gymnasium responsible for an echo in the detection of the whistle blow. In fact, the presence of an echo tends to elongate the envelope noticeably and slightly modulate its response. In that case, the reference envelope is modified so that it corresponds to the exact signature of the whistle blow in that specific environment. This modification may be done beforehand with several test whistle blows in the silent gymnasium.

According to one feature, the digital processing means also comprise means for comparing the amplitude of the digital measuring signals with a reference amplitude, so as to detect a signal with a high acoustic power when the amplitude of the digital measuring signal is higher than the reference amplitude.

In this way, as a complement to the analysis of the envelope profile, the detection of the whistle blow is also done by analyzing the amplitude or acoustic power, since a whistle blow generally assumes the form of an acoustic signal with a high acoustic power, where the ambient noise and surrounding voices (voices of the players, coaches, referees, spectators, etc.) are more moderated. Typically, the acoustic power of a whistle is 10 to 15 dB higher than that of a human yell.

According to another feature, the digital processing means also comprise means for comparing the frequencies of the digital measuring signals with a reference frequency range, so as to detect a signal emitted in said reference frequency range.

Thus, as a complement to the analysis of the envelope profile, the detection of the whistle blow is also done by analyzing the frequency of the digital measuring signals, since a whistle blow is emitted in a specific treble frequency range.

Advantageously, the digital processing means are designed so as to successively implement:
the means for comparing the amplitude of the digital measuring signals with a reference amplitude; then
the means for comparing the time profile of the amplitude envelope of the digital measuring signals with a time profile of a reference envelope; and lastly
the means for comparing the frequencies of the digital measuring signals with a reference frequency range.

In this embodiment, the detection is done in three successive phases:
a first phase for comparing the amplitude of the digital measuring signals with a reference amplitude, making it possible to detect signals with a high acoustic power, the acoustic power being very characteristic of the whistle blow. This first phase makes it possible to avoid carrying out the other phases if no sufficiently powerful sound has been detected;
a second phase for comparing the time profile of the amplitude envelope of the digital measuring signals with a time profile of a reference envelope, this envelope profile constituting a very specific signature of the whistle blow, such that this second phase guarantees detection of the whistle blow; and
a third phase for comparing the frequencies of the digital measuring signals with a reference frequency range, so as ultimately to confirm detection of the whistle blow.

The series of these three phases guarantees the detection of the whistle blow nearly 100% of the time, and also guarantees that no other outside acoustic signal will be confused with the whistle blow, thereby preventing incorrect triggering of the stoppage of the playing time.

The various reference parameters (reference amplitude, reference envelope and reference frequency range) should be brought close to those of the referenced whistles; as a reminder, the whistles are generally approved and referenced by the federations in charge of these sporting events or by any other accredited organization for those sporting events. Thus, the portable system includes an internal memory in which these reference parameters are stored, preferably with the possibility of modifying and/or replacing them to be able to adapt this portable system to several types of whistle and/or the presence of an echo as described above.

According to another advantageous feature of the invention:
the digital processing means are designed to process and analyze the digital measuring signals so as to detect, among the acoustic signals measured by said acoustic measuring means, a specific voice order issued by the referee to signal resumption of the playing time, said digital processing means delivering a digital signal to resume the playing time in response to the detection of said voice order; and
the transmission means are designed to transmit said digital signal to resume the playing time.

Once the countdown of the playing time is stopped after the detection of an acoustic refereeing signal indicating stoppage of the playing time, this characteristic makes it possible to restart the countdown of the playing time locally and automatically, using the same communication channel as for the digital refereeing signal, i.e. the aforementioned the digital radio link that has all of the advantages already described.

According to one possibility of the invention, the system also comprises means for manually actuating resumption of the playing time, in particular of the switch or numeric keypad key type, designed to be actuated manually by the referee to signal resumption of the playing time; and furthermore
the digital processing means are connected to said actuating means, said digital processing means delivering a digital signal to resume the playing time in response to actuation of the actuating means by said referee; and
the transmission means are designed so as to transmit said digital signal to resume playing time.

Once the countdown of the playing time has been stopped after the detection of an acoustic refereeing signal indicating stoppage of the playing time, this feature makes it possible to restart the countdown of the playing time manually and automatically, using the same communication channel as for the digital refereeing signal, i.e. the aforementioned digital radio link that has all of the advantages already described.

According to another possibility of the invention, the system also comprises amplification means arranged at the output of the acoustic measuring means to amplify the raw analog measuring signals before being converted by the analog/digital conversion means.

These amplification means aim to perform a simple amplification of the raw analog measuring signals, without other analog processing, so as not to color them.

According to another possibility of the invention, the transmission means are designed to transmit the digital refereeing signal several times, in particular at regular time intervals preferably of approximately 10 to 50 ms, over a predetermined period of time.

In this way, and owing to the digital radio link, the digital refereeing signal, which will serve to initiate stoppage and/or resumption of the playing time in the fixed system (as described later), may be transmitted several times to be sure that the latter is indeed received by the fixed system.

Thus, out of three consecutive transmissions of the digital refereeing signal, it is tolerable to “lose” one or two transmissions, in other words not to receive one or two transmissions at the fixed system of the score table. In fact, by losing two transmissions out of three, the fixed system still receives the digital refereeing signal at most within a maximum period of 30 to 150 ms after its transmission, which is completely acceptable to manage the time of a sporting event and remains below the maximum allowable delay to stop the countdown of the playing time.

In the radio communications field, it is traditional to perform transmissions at regular time intervals in the vicinity of 10 to 30 ms, such that it is even possible to consider having an 80% loss in the transmission, thereby offering great flexibility in the conveyance of the digital signals by the digital radio link.

Advantageously, the transmission means are configured to transmit several digital signals on a same frequency channel, called the communication channel, using a time-multiplexing communication method allowing a transmission of data in successive cycles on the same communication channel, each cycle being divided into a plurality of time slots, and each cycle having a time slot reserved for the transmission of the digital refereeing signal. Of course, the choice of the time slot may potentially change from one cycle to the next, for example depending on priority considerations in the transmission of the data.

This type of communication method thus makes it possible to use the communication channel, in other words the aforementioned digital radio link, to convey several types of digital data and not only the digital refereeing signal, such as for example digital audio data allowing wireless audio communication, multiple users, with time multiplexing in a single channel. The digital data is thus distributed in the form of data packets conveyed in the time slots of the successive cycles. It is understood that, within the meaning of the present invention, a “cycle” constitutes a cycle of a communication or transmission channel, said “cycle” sometimes wrongly being called a “frame.”

In one particular embodiment, each cycle has a time slot reserved for the transmission of the digital signal for resumption of the playing time defined above, so as to take advantage of that communication channel to transmit that digital signal to resume the playing time.

Advantageously, the transmission means are configured to incorporate a cyclical redundancy signal into one of the time slots of each cycle that makes it possible to verify the integrity of the transmitted cycles.

In this way, the cycles (or frames) incorporate a cyclical redundancy code that makes it possible to verify the proper integrity of the cycles, such that:
either the cycle is correct and then its content is certainly valid, and in particular the digital refereeing signal;
or the cycle is corrupted and is then ignored in its entirety, including the digital refereeing signal, such that false starts due to disruptions in the digital radio link (which are very rare) are ruled out.

The invention also relates to a time-multiplexing digital audio communication terminal allowing a transmission of audiometric data in successive cycles of a same communication channel, each cycle being divided into a plurality of time slots, comprising:
audio communication means making it possible to receive and transmit the voice, in particular comprising a microphone and loudspeaker;
digital audio conversion means connected with the audio communication means so as to convert the voice into audiometric data, and vice versa;
control means, in particular of the microprocessor type, connected with the digital audio conversion means and designed to receive the audiometric data as input and deliver it as output at time slots of the cycles of the communication channel, and vice versa; and
transceiver means adapted to receive and transmit the audiometric data in the successive cycles of the same communication channel; and
a portable pickup and detection system according to the invention, said portable pickup and detection system being incorporated into said digital audio communication terminal with:
   its acoustic measuring means, which are incorporated into the audio communication means;
   its analog/digital conversion means, which are incorporated into the digital audio conversion means;
   its digital processing means, which are incorporated into the control means; and
   its transmission means, which are incorporated into the transceiver means, each cycle of the communication channel having a time slot reserved for the transmission of the digital refereeing signal.

The invention also relates to a fixed system for controlling the playing time of a sporting event, in particular of the type encountered in basketball or other group sports, said fixed system being designed to be in radio connection with at least one portable pickup and detection system according to the invention, and comprising:
receiving means wirelessly connected with the transmission means of the or each portable pickup and detection system, said receiving means being designed to receive the or each digital refereeing signal;
command means connected to the receiving means and designed to deliver a referee command signal in response to the reception of a digital refereeing signal by the receiving means; and
means for counting down the playing time, in particular of the stopwatch type, connected to the command means and configured to stop and/or resume the countdown of the playing time in response to the delivery of the referee command signal.

This fixed system is thus particularly adapted to the portable system described above, according to an obvious technical link of the transceiver type. In fact, this fixed system does not include any means for analyzing or processing the digital refereeing signal, the detection of the whistle blow having already been done in the portable system.

This fixed system receives the digital refereeing signal, which serves to trigger the stoppage of the countdown of the playing time through the command means; this system is of course adapted to receive the digital refereeing signal and, if applicable, distinguish it from other digital data in the context of time-multiplexing communication.

According to one advantageous feature of the invention:
the receiving means are designed to receive the or each digital signal for resuming the playing time defined above;
the command means are designed to generate a resumption command signal in response to the reception of a digital resumption signal of the playing time by the receiving means; and
the means for counting down the playing time are configured to start or restart the countdown of the playing time in response to the delivery of the resumption command signal.

The invention also relates to an installation for controlling the playing time of a sporting event, in particular of the type encountered in basketball or other group sports, said installation including:
at least one portable pickup and detection system according to the invention; and
a fixed system for controlling the playing time according to the invention and wirelessly connected with the or each portable pickup and detection system.

The present invention also relates to an installation for controlling the playing time of a sporting event, in particular of the type encountered in basketball or other group sports, said installation including:
several digital audio communication terminals designed to be worn by the referees for the sporting event to allow audio communication between said referees, where at least one of said communication terminals is according to the invention and incorporates a portable system according to the invention; and
a fixed system for controlling the playing time according to the invention and wirelessly connected with the or each portable pickup and detection system equipping the digital audio communication terminal(s).

### BRIEF DESCRIPTION OF THE DRAWINGS

Other features and advantages of the present invention will appear upon reading the following detailed description of one non-limiting embodiment, done in reference to the appended figures, in which:

FIG. 1 is a diagrammatic view of an installation for controlling the playing time of a sporting event according to the invention, comprising a portable pickup and detection system and a fixed system for controlling the playing time of the sporting event, all according to the invention;

FIG. 2 is a diagrammatic view of digital processing means of a portable pickup and detection system according to the invention;

FIG. 3 is a diagrammatic view of a digital audio communications terminal according to the invention, incorporating a portable pickup and detection system according to the invention;

FIGS. 4a and 4b are diagrammatic views of two successive cycles (or frames) of a communication channel used for the radio transmission of the digital refereeing signal between the portable system and fixed system;

FIG. 5 is a diagrammatic view of a mixed data packet grouping together several categories of data, including the digital refereeing signal; and

FIG. 6 is a diagrammatic illustration of the time profile of a first reference envelope and a second reference envelope after taking the echo into account.

### DETAILED DESCRIPTION

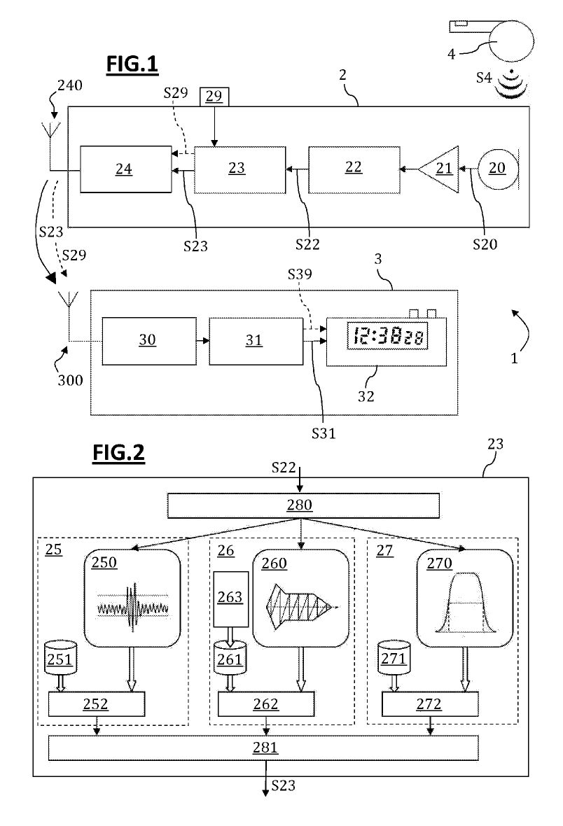

In reference to FIG. 1, an installation 1 for controlling the playing time of a sporting event, for example such as a basketball game, according to the invention includes:
at least one portable pickup and detection system 2, designed to be worn by a referee for the sporting event; and
a fixed system 3 for controlling the playing time connected by radio with the or each portable system 2 and designed for example to be positioned on a score table.

The portable system 2 is designed to pick up and detect an acoustic so-called refereeing signal S4 signaling a stop and/or start of the playing time of the sporting event. This acoustic refereeing signal S4 may be emitted by the referee or one of the referees for the sporting event, using a whistle 4, which is then referred to as a whistle blow S4 signaling stoppage of the playing time, or resumption of the playing time.

In the rest of the description, the acoustic refereeing signal will be considered to be a whistle blow S4 that signals only the stoppage of the playing time, with the understanding that other types of acoustic signal may be considered.

This portable system 2 comprises acoustic measuring means 20, for example of the microphone type, designed to:
measure the external acoustic signals coming from all acoustic sources present during sporting event (spectators, referees, players, coaches, whistles, commentators, advertisements, crunching of shoe soles, etc.) including the whistle blow S4 from the whistle 4 of the referee(s); and to
deliver the raw analog measuring signals S20 in response to the measurement of the external acoustic signals.

This portable system 2 comprises, as output from the acoustic measuring means 20, amplification means 21 designed to amplify the raw analog measuring signals S20.

This portable system 2 comprises, as output from the amplification means 21, analog/digital conversion means 22 designed to convert the raw analog measuring signals S20, previously amplified by the amplification means 21, into digital measuring signals S22, also called audiometric data “Audio” in the case of integration of the portable system 2 into a communication terminal 8 as described below.

In this way, the raw analog measuring signals S20 are immediately sampled to digitize them; no analog processing is done on the signals, such as filtering or compression processing, aside from a simple, transparent amplification, so as not to color them.

Next, this portable system 2 comprises, as output from the analog/digital conversion means 22, digital processing means 23, for example of the digital signal processor (DSP) type, designed to process and analyze the digital measuring signals S22 so as to detect the transmission or lack thereof of the whistle blow S4 among the other external acoustic signals measured by the acoustic measuring means 20. These digital processing means 23 deliver a digital refereeing signal S23 of the playing time in response to the detection of the whistle blow S4; this digital refereeing signal S23 thus forms a digital signal indicating the detection of the whistle blow and designed to command the stoppage of the playing time.

Lastly, this portable system 2 comprises transmission means 24 connected to the digital processing means 23 and designed to transmit the digital refereeing signal S23, by means of an antenna 240.

In reference to FIG. 2, to perform the analysis, the digital processing means 23 comprise three distinct comparison means:
first means 25 for comparing the amplitude of the digital measuring signals S22 with a reference amplitude, so as to detect a signal with a high acoustic power when the amplitude of the digital measuring signals is higher than the reference amplitude;
second means 26 for comparing the time profile of the amplitude envelope of the digital measuring signals S22 with a time profile of a reference envelope, so as to detect a signal having a time profile of the acoustic power envelope that substantially corresponds to the time profile of the reference envelope; and
third means 27 for comparing the frequencies of the digital measuring signals S22 with a reference frequency range, so as to detect a signal transmitted in said reference frequency range.

The digital processing means 23 comprise, as input, a distribution block 280 for distributing the digital measuring signals S22 in the three comparison means 25, 26, 27.

The first comparison means 25, called first comparison block, comprise an extraction block 250 for extracting the amplitude of the digital measuring signals S22, a memory block 251 in which the reference amplitude is stored, and a comparison block 252 for comparing the amplitude of the digital measuring signals S22 and the reference amplitude.

The second comparison means 26, called second comparison block, comprise an extraction block 260 for extracting the time profile of the amplitude envelope of the digital measuring signals S22, a memory block 261 in which the reference envelope is stored, and a comparison block 262 for comparing the time profiles of the amplitude envelopes of the digital measuring S22 and reference signals.

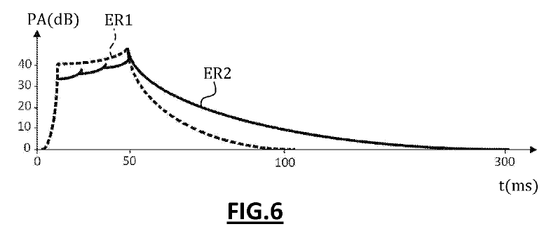

FIG. 6 illustrates the time profile of a first reference envelope ER1 and a second reference envelope ER2, each corresponding to a variation curve of the acoustic power PA as a function of time t, PA being expressed for the purposes of the illustration in decibels (dB) and t being expressed in milliseconds (ms) in FIG. 6.

The time profile of the first reference envelope ER1 or the second reference envelope ER2 is defined by the following parameters:
an increase in the acoustic power by a first predetermined power value, in particular approximately 30 to 40 dB, relative to a base power associated with an ambient noise background, over a first period of time, in particular in the vicinity of several milliseconds;
a leveling off of the acoustic power over a second period of time, in particular approximately 50 ms, following the first period of time and where the second period of time is longer than the first period of time, this leveling off potentially having an increase in the acoustic power by a second predetermined power value, in particular approximately 5 to 6 dB, over the second period of time, the second power value being lower than the first power value; and
a decrease in the acoustic power until it substantially reaches the base power, over a third period of time, in particular approximately 50 to 400 ms, following the second period of time, where the third period of time is longer than the second period of time.

The first reference envelope ER1 corresponds to the situation with no echoes or no taking into account of the echo, with:
the increase of approximately 40 dB from a zero base power over the first period, which lasts approximately 5 ms;
the leveling off over the second period, which lasts approximately 45 ms, with an increase between approximately 5 and 10 dB between the beginning and the end of the leveling off;
the decrease with return to the zero base power over the third period, which lasts between approximately 50 and 60 ms.

To take the presence of the echo into account, the second comparison means 26 comprise parameterization means 263 for configuring the time profile of the reference envelope stored in the memory block 261. In this way, the processing also takes into account the possibility of an echo in the gymnasium, which will noticeably elongate the time profile and slightly modulate its response.

The second reference envelope ER2 corresponds to a situation where the echo is taken into account, after modifying the first reference envelope ER1, with:
the increase by approximately 35 dB from a zero base power over the first period, which lasts approximately 5 ms;
the leveling off over the second period, which lasts approximately 45 ms, with an increase between approximately 10 and 15 dB between the beginning and the end of the leveling off, and with several increase/decrease series, called echo peaks;
the decrease with return to the zero base power over the third period, which lasts between approximately 150 and 250 ms.

The taking into account of the echo in the gymnasium translates to differences between the first reference envelope ER1 and the second reference envelope ER2 that are essentially related to the resonance of the room. The resonance of the room causes two effects related to the acoustic impulse response of the room, i.e.:
an amplitude modulation through “rapid echo,” which amounts to the series of Echo peaks in the leveled off period; and
an elongation of the acoustic impulse by damping, which amounts to the elongation of the third period, in other words the return to zero.

These two effects vary as a function of the distance to the walls in the volume of the room, resulting in the need to perform a series of initial tests to measure those effects and thus obtain the second reference envelope ER2, which translate the possible influence of the room on the time signature of the whistle blow as precisely as possible. In other words, the second comparison means 26 incorporate the parameterization means 263 so that the whistle detection algorithm accepts the possible variations of the two aforementioned effects to incorporate the acoustic echo.

The third comparison means 27, called third comparison block, comprise an extraction block 270 for extracting the frequencies of the digital measuring signals S22, a memory block 271 in which the reference frequency range is stored, and a comparison block 272 for comparing the frequencies of the digital measuring signals S22 and the reference frequency range.

The digital processing means 23 are designed to successively implement the first comparison means 25, then the second comparison means 26, and lastly the third comparison means 27.

In this way, the processing method used to detect the whistle blow S4 comprises the following three successive phases:
time detection of a signal with a strong audio power, where the ambient noise or voice of the referee is more moderated, seen by the acoustic measuring means 20, using the first comparison block 25;
time detection of the envelope of the whistle blow S4, which, for example, has a very sharp acoustic power increase, then a quasi-fixed established acoustic power followed by a slow decrease in the acoustic power (this profile being very distinct from the ambient voice signals and the ambient noise), using the second comparison block 26; and
frequency analysis of the whistle blow S4 to perform the time measurements, for example with detection of the dominant treble, using the third comparison block 27.

The digital processing means 23 lastly include a control block 281 that analyzes the results of the various comparisons done in the three comparison blocks 25, 26, 27 and, as a function of those results, does or does not deliver the digital refereeing signaled S23.

The fixed system 3 includes:
receiving means 30 wirelessly connected with the transmission means 24 of the or each portable system 2, by means of the antenna 300, said receiving means being designed to receive the or each digital refereeing signal S23;
control means 31 connected to the receiving means 30 and designed to deliver a referee control signal S31 in response to the reception of a digital refereeing signal S23 by the receiving means 30; and
means for counting down the playing time 32, in particular of the stopwatch type, connected to the command means 31 and configured to stop (and/or start, depending on the case) the countdown of the playing time in response to the delivery of the referee control signal S23.

Thus, once the digital refereeing signal S23 is present at the score table, the stoppage operation (and/or resumption operation, depending on the case) for the countdown of the playing time becomes a simple electrical action equivalent to pressing the stop button of the stopwatch. In the case at hand, the receiving means 30 and the command means 31 together form a single remote control system that in no way participates in the act of detecting the whistle blow S4.

The detection of the signature of a whistle blow S4 is a mechanism similar to that used for the extraction processing of the voice in the noise. As a result, the detection of the whistle blow may be an accessory of a digital audio communications terminal 8, by incorporating the portable system 2 into that type of communication terminal 8, or made up of a completely separate autonomous system, with the independent portable system 2.

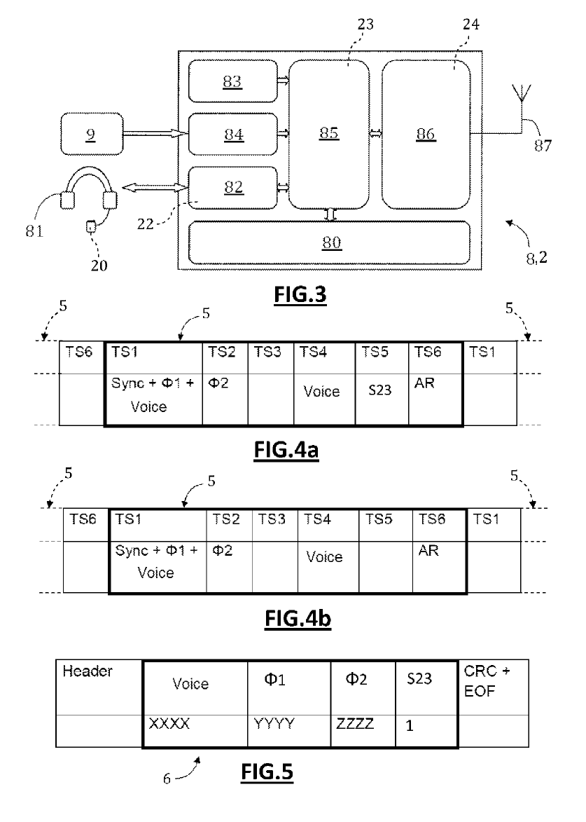

In reference to FIG. 3, this portable system 2 may therefore be incorporated into a time-multiplexing digital audio communications terminal 8 allowing a transmission of audiometric data in successive cycles 5 of a same communication channel, each cycle 5 being divided into relative time slots TS1 to TS6, as illustrated in FIGS. 4a and 4b.

In that case, the installation 1 may comprise several communication terminals 8 where at least one of said communication terminals 8 incorporates a portable system 2, each communication terminal 8 being designed to be worn by a referee for the sporting event to allow audio communication between the referees, and the fixed station 3 is wirelessly connected with the or each portable system 2.

Time division multiple access communication methods are commonly used, in particular in mobile telephones. Time division multiple access is a time multiplexing mode making it possible to transmit several digital signals on a same frequency channel. In this way, several users, here the referees, share the same channel. The data flow is divided into data packets 6 and transmitted in the communication channel divided into successive periodic cycles 5.

FIG. 3 illustrates one such communication terminal 8 comprising:
a man-machine interface 80, or MMI, in particular allowing the referee to transmit orders or command data, such a man-machine interface 80 for example made in the form of a keyboard, keypad, touchscreen, or similar mechanism;
audio communication means 81 allowing the reception and transmission of the voice and other audio sounds, including the whistle blow S4, in particular comprising a microphone and loudspeaker, such audio communication means 81 being able to be made in the form of a communication headset or an earpiece of the mobile telephone type;
audiometric conversion means 82, in particular of the digital audio interface type, connected with the audio communication means 81 so as to convert the sounds, including the voice and the whistle blow S4, into audiometric data “Audio” comprising, inter alia, the voice data “voice,” and vice versa;
possibly one or more onboard sensors 83 designed to measure a local parameter, for example such as an accelerometer or a temperature sensor, and converted into measurement data “Mes”;
possibly a pickup interface 84 connected with one or more external detection terminals 9 designed to measure an external parameter able to influence the sporting event in progress, for example such as a device for measuring wind and/or sunshine, and to convert it into measurement data “Mes.”

The communication terminal 8 also comprises control means 85, in particular of the microprocessor or communication processor type, connected with the digital audio conversion means 82, and if applicable with the onboard sensor(s) 83 and the pickup interface 84, designed to:
receive, as input, the audiometric data “Audio” and potentially measurement data “Mes”;
digitally process that data so as to extract the voice data “voice” from the ambient noise (in particular using voice recognition software); and
deliver, as output, the voice data “voice” and potentially measurement data “Mes” in time slots of the cycles 5 of the communication channel according to a time-multiplexing communication method between several communication terminals, and vice versa.

The communication terminal 8 lastly comprises transceiver means 86, in particular of the radio digital motor type, connected with the control means 85 and adapted to receive and transmit the voice data “voice” and potentially measurement data “Mes” in the successive cycles 5 of the same communication channel, by means of an antenna 87.

The portable system 2 is thus incorporated into this digital audio communications channel 8 with:
its acoustic measuring means 20, which are incorporated into the audio communication means 81;
its analog/digital conversion means 22, which are incorporated into the digital audio conversion means 82;
its digital processing means 23, which are incorporated into the control means 85; and
its transmission means 24, which are incorporated into the transceiver means 86, each cycle 5 of the communication channel having a time slot reserved for transmission of the digital refereeing signal S23.

In this way, the control means 85 deliver, as output, the digital refereeing signal S23, following the detection of the whistle blow S4 by the digital processing means 23 incorporated into said control means 85, while incorporating that digital refereeing signal S23 into a time slot TS5 of one or more cycles 5 of the communication channel according to a time-multiplexing communication method, as illustrated in FIG. 4a.

Thus, once the whistle blow S4 is detected, the digital refereeing signal S23 is emitted, for example in the form of a bit activated by the digital processing means 23. Then, that digital refereeing signal S23 is incorporated into the digital cycles (or frames) emitted periodically, and which may transport digital audio voice data. This process only requires a few milliseconds, and therefore does not delay the stoppage of the countdown of the playing time.

FIG. 4a shows one example of a communication cycle 5 in which:
a first communication terminal 8 worn by a first referee, provided with an integrated sensor 83, communicates digital audio voice data “voice,” first measurement data Mes1 and a synchronization signal Sync in the time slot TS1 of the cycle 5;
a detection terminal 9 communicates second measurement data Mes in the time slot TS2;
a second communication terminal 8 worn by a second referee communicates digital audio voice data “Voice” in time slot TS4;
one of the two communication terminals 8 communicates the digital refereeing signal S23, in this case the communication terminal 8 worn by the referee originating the whistle blow.

As shown in FIG. 4b, the fixed system 3 may communicate acknowledge of receipt data AR (or return receipt signal) in the cycle 5 following the aforementioned cycle 5 and visible in FIG. 4a, so as to acknowledge receipt of the digital refereeing signal S23, and potentially to indicate actuation or the lack thereof of the stoppage of the countdown of the playing time. In that case, the fixed system 3 also comprises transmission means, and its control means 31 are designed to deliver an acknowledgment of receipt signal in response to the stoppage of the stopwatch 32.

As illustrated in FIG. 5, the transmission time of each user is therefore shared between the digital audio voice data “Voice,” the digital refereeing signal S23 and, if applicable, measurement data “Mes,” in this case first measurement data Mes1 and second measurement data Mes2, reunited within a data packet 6 reunited in a mixed data frame. The nature of the header of the data packet 6 may for example determine the format and content of the packet (quantity of measurement data, presence or absence of digital audio data, measurement data, dimension of the packets, etc.), before closure of the packet by a trailer “CRC+EOF.” The digital refereeing signal S23 may correspond to a single detection bit, said single bit assuming the value 1 in the event a whistle blow S4 is detected, and the value 0 in the absence of detection of the whistle blow S4.

In a digital communication installation, the notion of real-time is essential, and the cycles 5 are transmitted very regularly, for example every 10 to 30 ms. This regularity in particular makes it possible to verify the proper operation and availability of the portable 2 and fixed 3 systems of the installation 1. In this way, the transmission means 24, and more generally the transceiver means 86, are designed to transmit the digital refereeing signal S23 several times with regular time spacing in the vicinity of 10 to 30 ms, over a predetermined period of time.

In light of this timeline of the exchanges, the digital refereeing signal S23 is conveyed in 10 to 30 ms to the fixed system 3 of the score table, or twice or three times as long if several cycles 5 are lost. These timeframes in any case remain significantly below the maximum allowable delay to stop the countdown of the playing time.

The digital refereeing signal S23, making up the detection information for the whistle blow S4, may thus be transmitted for several seconds in order to ensure that it is transported. If applicable, the digital refereeing signal S23 may be discharged by a return, of the acknowledgment of receipt AR signal type, generated by the fixed system 3 once the countdown of the playing time has been stopped.

Furthermore, the transmission means 24, and more generally the transceiver means 86, are configured to incorporate, into one of the time slots of each cycle 5, a cyclical redundancy signal that makes it possible to verify the integrity of the transmitted cycles, such that:
if the cyclical redundancy signal is valid, then the cycle (or frame) is good and its content is then certainly valid, and in particular the digital refereeing signal S23;
if the cyclical redundancy cycle is not valid, then the cycle is corrupted and is then ignored in its entirety, including the digital refereeing signal S23.

If too many cycles are missing or damaged, for example more than 30% of the cycles, it is possible to indicate to the operator that there is a malfunction or to take measures to reduce the error, for example such as increasing radio power levels, changing radio channels, etc.

Just as the whistle blow S4 is detected to stop the countdown of the playing time, it is possible to restart that same countdown of the playing time upon an action by the referee.

A first possibility for resuming the countdown of the playing time is to provide audio detection of a voice order from the referee, for example such as a keyword, for instance “Start” or “Chrono.” In that case, the portable system 2 is designed such that:
its digital processing means 23 process and analyze the digital acoustic measuring signals so as to detect, among the acoustic signals measured by the acoustic measuring means 20, a specific voice order transmitted by the referee to signal the resumption of the playing time, these digital processing means 23 delivering a digital resumption signal S29 for the playing time in response to the detection of said voice order; and
its transmission means 24 are designed to transmit said digital resumption signal S29 to start the playing time.

This first possibility is particularly well suited to cases where the portable system 2 is incorporated into a communication terminal 8.

As illustrated in FIG. 1, a second possibility for restarting the playing time countdown is to provide manual detection of an action by the referee, for example such as pressure on a button or switch. In that case, the portable system 2 also comprises manual actuating means 29 for actuating resumption of the time, in particular of the switch or keypad key type, designed to be actuated manually by the referee to indicate resumption of playing time, as illustrated in FIG. 1. Furthermore, the digital processing means 23 are connected to the actuating means 29, said digital processing means 23 delivering a digital resumption signal S29 to resume the playing time in response to the actuation of the manual actuating means 29 by the referee. Lastly, the transmission means 24 are designed to transmit said digital signal to resume the playing time.

These two possibilities for restarting the playing time countdown may be considered alone or in combination, and should be considered in the event the whistle blow S4 serves only to trigger stoppage of the playing time. As illustrated in FIG. 1, in both possibilities, the fixed system 3 is designed such that:
the receiving means 30 are designed to receive the or each digital resumption signal S29;
the control means 31 are designed to generate a resumption command signal S39 in response to the reception of a digital resumption signal S29 by the receiving means 30; and
the means for counting down the playing time 32 are configured to start or restart the countdown of the playing time in response to the delivery of the resumption command signal S39.

In both possibilities, this action for restarting the countdown of the playing time uses the same digital radio communication channel as during detection of the whistle blow S4 and stoppage of the countdown of the playing time. In this way, each cycle 5 of the communication channel may have a time slot reserved for the transmission of said digital signal for resuming the playing time S29.

Of course, the example embodiment described above is in no way limiting, and other details and improvements may be added to the installation and the systems according to the invention without going beyond the scope of the invention, where other elements may for example be incorporated into the installation.

1. A portable system for picking up and detecting acoustic so-called referring signal of the whistle blow type, that signals a stop and/or start in the playing time of a sporting event such as a basketball match or other groups sport, the portable system being designed to be worn by a referee for the sporting event and comprising:
acoustic measuring means of the microphone type, designed to measure the outside acoustic signals and deliver raw analog measuring signals in response to the measurement of the outside acoustic signal;
analog/digital conversion means connected to the acoustic measuring means and designed to convert the raw analog measuring signals into digital measuring signals;
digital processing means of the digital signal processor type, connected to the analog/digital conversion means and designed to process and analyze the digital measuring signal so as to detect the transmission or lack thereof of the acoustic refereeing signal from among the external acoustic signals measured by said acoustic measuring means, said digital processing means delivering a digital refereeing signal in response to the detection of the acoustic refereeing signal; and
transmission means connected to the digital processing means and designed to emit said digital refereeing signal;
wherein the digital processing means comprise means for comparing the time profile of the amplitude envelope of the digital measuring signals with a time profile of a reference envelope, so as to detect a signal having a time profile of the acoustic power envelope that corresponds substantially to the time profile of the reference envelope.

2. The portable pickup and detection system according to claim 1, wherein the time profile of the reference envelope is defined by the following parameters:
an increase in the acoustic power by a first predetermined power value relative to a base power associated with an ambient background noise, over a first period of time in the vicinity of several milliseconds;
an acoustic power leveling off over a second period of time of approximately 50 ms, following the first period of time and where the second period of time is longer than the first period of time, this leveling off potentially having an increase in the acoustic power by a second predetermined power value over the second period of time, the second power value being lower than the first power value; and
a decrease in the acoustic power until the base power is substantially reached, over a third period of time following the second period of time, where the third period of time is longer than the second period of time.

3. The portable pickup and detection system according to claim 1, wherein the digital processing means comprise parameterization or modification means for the time profile of the reference envelope so as to account for the presence of an echo inside a gymnasium.

4. The portable pickup and detection system according to claim 1, wherein the digital processing means also comprise means for comparing the amplitude of the digital measuring signals with a reference amplitude, so as to detect a signal with a high acoustic power when the amplitude of the digital measuring signal is higher than the reference amplitude.

5. The portable pickup and detection system according to claim 1, wherein the digital processing means also comprise means for comparing the frequencies of the digital measuring signals with a reference frequency range, so as to detect a signal emitted in said reference frequency range.

6. The portable pickup and detection system according to claim 4, wherein the digital processing means are designed so as to successively implement:
the means for comparing the amplitude of the digital measuring signals with a reference amplitude; then
the means for comparing the time profile of the amplitude envelope of the digital measuring signals with a time profile of a reference envelope; and lastly
the means for comparing the frequencies of the digital measuring signals with a reference frequency range.

7. The portable pickup and detection system according to claim 1, wherein:
the digital processing means are designed to process and analyze the digital measuring signals so as to detect, among the acoustic signals measured by said acoustic measuring means, a specific voice order issued by the referee to signal resumption of the playing time, said digital processing means delivering a digital signal to resume the playing time in response to the detection of said voice order; and
the transmission means are designed to transmit said digital signal to resume the playing time.

8. The portable pickup and detection system according to claim 1, also comprises means for manually actuating resumption of the playing time of the switch or numeric keypad key type, designed to be actuated manually by the referee to signal resumption of the playing time; and wherein
the digital processing means are connected to said actuating means, said digital processing means delivering a digital signal to resume the playing time in response to actuation of the actuating means by said referee; and
the transmission means are designed so as to transmit said digital signal to resume playing time.

9. The portable pickup and detection system according to claim 1, also comprising amplification means arranged at the output of the acoustic measuring means to amplify the raw analog measuring signals before being converted by the analog/digital conversion means.

10. The portable pickup and detection system according to claim 1, wherein the transmission means are designed to transmit the digital refereeing signal several times at regular time intervals over a predetermined period of time.

11. The portable pickup and detection system according to claim 1, wherein the transmission means are configured to transmit several digital signals on a same frequency channel, called the communication channel, using a time-multiplexing communication method allowing a transmission of data in successive cycles on the same communication channel, each cycle being divided into a plurality of time slots, and each cycle having a time slot reserved for the transmission of the digital refereeing signal.

12. The portable pickup and detection system according to claim 11, wherein each cycle has a time slot reserved for the transmission of the digital signal for resumption of the playing time.

13. The portable pickup and detection system according to claim 11, wherein the transmission means are configured to incorporate a cyclical redundancy signal into one of the time slots of each cycle that makes it possible to verify the integrity of the transmitted cycles.

14. A time-multiplexing digital audio communication terminal allowing a transmission of audiometric data in successive cycles of a same communication channel, each cycle being divided into a plurality of time slots, comprising:
audio communication means making it possible to receive and transmit the voice comprising a microphone and loudspeaker;
digital audio conversion means connected with the audio communication means so as to convert the voice into audiometric data, and vice versa;
control means of the microprocessor type, connected with the digital audio conversion means and designed to receive the audiometric data as input and deliver it as output at time slots of the cycles of the communication channel, and vice versa; and
transceiver means adapted to receive and transmit the audiometric data in the successive cycles of the same communication channel; and
a portable pickup and detection system according to claim 1, said portable pickup and detection system being incorporated into said digital audio communication terminal with:
its acoustic measuring means, which are incorporated into the audio communication means;
its analog/digital conversion means, which are incorporated into the digital audio conversion means;
its digital processing means, which are incorporated into the control means; and
its transmission means, which are incorporated into the transceiver means, each cycle of the communication channel having a time slot reserved for the transmission of the digital refereeing signal.

15. A fixed system for controlling the playing time of a sporting event, in particular of the type encountered in basketball or other group sports, said fixed system being designed to be in radio connection with at least one portable pickup and detection system according to claim 1, and comprising:
receiving means wirelessly connected with the transmission means of the or each portable pickup and detection system, said receiving means being designed to receive the or each digital refereeing signal;
command means connected to the receiving means and designed to deliver a referee command signal in response to the reception of a digital refereeing signal by the receiving means; and
means for counting down the playing time of the stopwatch type, connected to the command means and configured to stop and/or resume the countdown of the playing time in response to the delivery of the referee command signal.

16. The fixed system for controlling the playing time according to claim 15, wherein the or at least one portable pickup and detection system (2) is according to claim 8, and wherein:
the receiving means are designed to receive the or each digital signal for resuming the playing time;
the command means are designed to generate a resumption command signal in response to the reception of a digital resumption signal of the playing time by the receiving means; and
the means for counting down the playing time are configured to start or restart the countdown of the playing time in response to the delivery of the resumption command signal.

17. An installation for controlling the playing time of a sporting event, in particular of the type encountered in basketball or other group sports, said installation including:
at least one portable pickup and detection system according to claim 1; and
a fixed system for controlling the playing time according to claim 15 and wirelessly connected with the or each portable pickup and detection system.

18. An installation for controlling the playing time of a sporting event, in particular of the type encountered in basketball or other group sports, said installation including:
several digital audio communication terminals designed to be worn by the referees for the sporting event to allow audio communication between said referees, where at least one of said communication terminals is according to claim 14; and
a fixed system for controlling the playing time according to claim 15 and wirelessly connected with the or each portable pickup and detection system equipping the digital audio communication terminal(s).
